(19) United States
(12) Patent Application Publication
(10) Pub. No.: US 2009/0153929 A1
(43) Pub. Date: Jun. 18, 2009

(54) APPARATUS FOR RECORDING/REPRODUCING HOLOGRAPHIC INFORMATION

(75) Inventors: Taek-seong JEONG, Suwon-si (KR); Jae-cheol Bae, Suwon-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/262,404

(22) Filed: Oct. 31, 2008

(30) Foreign Application Priority Data
Dec. 12, 2007 (KR) 2007-129084

(51) Int. Cl. G03H 1/04; G03H 1/22

(52) U.S. Cl. 359/31

(57) ABSTRACT

A holographic information recording and/or reproducing apparatus, including a light source to emit light; a polarization forming optical system to form a polarized signal beam and a polarized reference beam from the light emitted from the light source, wherein the polarized signal beam and the polarized reference beam are incident on a holographic information storage medium through an identical surface; a focusing optical system to focus the polarized signal beam and the polarized reference beam onto in the holographic information storage medium so that information is recorded by an interference pattern; and an adjustment optical system to set the focal positions of the polarized signal beam and the polarized reference beam, and to adjust a difference between a path of the polarized signal beam and a path of the polarized reference beam.

### CROSS-REFERENCE TO RELATED APPLICATION

This application claims the benefit of Korean Patent Application No. 2007-129084, filed in the Korean Intellectual Property Office on Dec. 12, 2007, the disclosure of which is incorporated herein by reference.

### BACKGROUND OF THE INVENTION

1. Field of the Invention

Aspects of the present invention relate to a holographic information recording and/or reproducing apparatus, and more particularly, to a holographic information recording and/or reproducing apparatus of a single-sided incidence type, in which a signal beam and a reference beam are incident on an identical surface.

2. Description of the Related Art

Data recording in a holographic data storage medium involves storing information in the form of an interference pattern on a material, such as photopolymer, which responds to the strength of light. The interference pattern is formed using two laser beams. The interference pattern is formed by a reference beam and a signal beam interfering with each other, causing chemical or physical changes in the photosensitive storage medium, thereby recording data. In order to reproduce information from the recorded interference pattern, a reference beam similar to the beam used when the information is recorded is emitted to the interference pattern recorded in the storage medium. The emitted reference beam is diffracted by the interference pattern, thereby restoring a signal beam and reproducing the information.

Recording methods using this hologram technology include a volume holographic method in which information is recorded and/or reproduced in units of pages, and a microholographic method in which information is recorded and/or reproduced in units of single bits. Although the volume holographic method has an advantage in that a large amount of information can be processed at the same time, it is difficult for the volume holographic method to be commercialized as an information storage apparatus for general consumers because the optical system should be adjusted very precisely.

In the microholographic method, two condensed light beams interfere with each other at the focus, thereby forming a fine interference pattern. By moving this interference pattern on the plane of a storage medium, a plurality of patterns are recorded to form a recording layer. Patterns are recorded by superimposing the recording layers in a depth direction of the storage medium, thereby recording information in a 3-dimensional (3D) manner.

However, a general microholographic recording and/or reproducing apparatus has an optical system for a signal beam and an optical system for a reference beam on each side of a storage medium, respectively. This arrangement complicates the optical systems, thereby increasing the total size of the optical system. Furthermore, in order to form an interference pattern using this double-sided incidence method, the signal beam and the focus of the reference beam should be focused in an area having a diameter of approximately 1 μm, and therefore each optical system should be arrayed with very high accuracy.

### SUMMARY OF THE INVENTION

Aspects of the present invention provide a single-side-incidence holographic information recording and/or reproducing apparatus in which a signal beam and a reference beam are incident on an identical surface.

Aspects of the present invention also provide a single-side-incidence holographic information recording and/or reproducing apparatus which can reduce the sizes and the numbers of components of a tilt optical system and an optical path difference adjustment optical system to adjust the spot position of at least one beam of a signal beam and a reference beam that are incident on a single surface.

According to an aspect of the present invention, a holographic information recording and/or reproducing apparatus is provided. The apparatus includes a first light source to emit light; a polarization forming optical system to form a polarized signal beam and a polarized reference beam from the light emitted from the first light source, wherein the polarized signal beam and the polarized reference beam are orthogonal to each other and incident on a holographic information storage medium through an identical surface; a focusing optical system to focus the polarized signal beam and the polarized reference beam onto the holographic information storage medium so as to record information by an interference pattern; and an adjustment optical system to set the focal positions of the polarized signal beam and the polarized reference beam, and to adjust a difference between a path of the signal beam and a path of the reference beam. The adjustment optical system includes a first adjustment member to set the focal positions of the polarized signal beam and the polarized reference beam emitted on the holographic information storage medium; a second adjustment member to adjust the path difference between the polarized signal beam and the polarized reference beam; and a polarization separation device to separate the polarized signal beam and the polarized reference beam, which are incident from a first optical system, into two paths based on the beams' polarization so as to direct the polarized signal beam to the first adjustment member and the reference beam to the second adjustment member.

According to another aspect of the present invention, the first adjustment member is a 2-dimensional (2D) tilt mirror to adjust the reflection angle of an incident beam in two dimensions.

According to another aspect of the present invention, the second adjustment member is a translation mirror to adjust the optical path length of the incident beam.

According to another aspect of the present invention, the first adjustment member is a one-dimensional (1D) tilt mirror to adjust the reflection angle of an incident beam.

According to another aspect of the present invention, the second adjustment member is a translation and a 1D tilt mirror to adjust the optical path length of the incident beam and to adjust the reflection angle of the incident beam in a direction different from that of the first adjustment member.

According to another aspect of the present invention, the adjustment optical system further includes a first quarter wave plate arranged between the polarization separation device and the first adjustment member and a second quarter wave plate arranged between the polarization separation device and the second adjustment member, wherein the polarization separation device is a polarization beam splitter.

According to another aspect of the present invention, the polarized signal beam is incident on the first adjustment member and the polarized reference beam is incident on the second adjustment member.

According to another aspect of the present invention, the holographic information storage medium includes a recording layer and a reflection layer; the focusing optical system causes the polarized signal beam to pass through the recording layer of the holographic information storage medium, reflect off the reflection layer, and condense in the recording layer, and causes the polarized reference beam to be condensed in the recording layer without passing through the recording layer or reflecting off the reflection layer.

According to another aspect of the present invention, the polarized light forming optical system comprises an active polarization changing device to convert the polarization of a beam emitted from the light source during a recording mode so as to include a first beam and a second beam having orthogonal polarizations, and to transmits the beam emitted from the first light source without changing polarization during a reproduction mode.

According to another aspect of the present invention, the polarized light forming optical system separates the optical paths of the polarized signal beam and the polarized reference beam and transmits the polarized signal beam and the polarized reference beam, and combines the optical paths so as to cause the polarized signal beam and the polarized reference beam to be incident on the adjustment optical system.

According to another aspect of the present invention, the polarized light forming optical system includes a first optical path changer to separate the beam emitted from the light source into the first beam and the second beam; a second optical path changer arranged at a location where the first and second beams separated by the first optical path changer intersect to separate an incident beam according to the polarization of the beam; a first mirror and a second mirror to bend the optical paths of the first beam and the second beam separated by the first optical path changer so that the first and second beams to intersect and are incident on the second optical path changer; a first half wave plate and a second half wave plate arranged on one of the paths of the first and second beams, at sides of the second optical path changer so as to convert one linearly polarized beam into the other polarized state, so that the first and second beams is transmitted from the second optical path changer in an identical polarization state; and an optical path combining unit to combine the paths of the first and second beams is transmitted from the second optical path changer; wherein one of the first and second beams is the polarized signal beam and the other of the first and second beams is the polarized reference beam.

According to another aspect of the present invention, the optical path combining unit includes a third optical path changer to unconditionally reflect a beam incident from the second optical path changer; a third mirror to bend the path of one beam of the first and second beams so as to make the first and second beams intersect, the one beam not being directed to the third optical path changer from the second optical path changer; and a fourth optical path changer to combine the paths of the first and second beams having different polarizations, wherein the first and second beams are incident and are intersecting each other by the third optical path changer and the third mirror.

According to another aspect of the present invention, one of the first and second half wave plates, on which the first or second beam incident on the second optical path changer from the first optical path changer is incident after passing through the second optical path changer, is an active wave plate operated to pass incident light without polarization change while the apparatus is operating in a reproduction mode.

According to another aspect of the present invention, the focusing optical system includes an objective lens.

According to another aspect of the present invention, the focusing optical system further includes a focus-changeable lens unit to vary the position of the focuses of the polarized signal beam and the polarized reference beam in the depth direction of the holographic information storage medium.

According to another aspect of the present invention, the focus-changeable lens unit includes a first focus-changeable lens unit and a second focus-changeable lens unit arranged along paths of the signal beam and the reference beam, and each of the polarized signal beam and the polarized reference beam travels separately.

According to another aspect of the present invention, the apparatus further includes a wave plate to convert a polarization of an incident beam between the objective lens and the adjustment optical system; and a photodetector to receive a reproduction beam reproduced from the holographic information storage medium while the apparatus is operating in a reproduction mode.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates an optical configuration of a holographic information recording and/or reproducing apparatus, according to an embodiment of the present invention;

FIG. 2 illustrates another example of an adjustment optical system illustrated in FIG. 1, according to an embodiment of the present invention;

FIG. 3 illustrates a reflection-type holographic information storage medium employed in a holographic information recording and/or reproducing apparatus, according to an embodiment of the present invention;

FIG. 4 illustrates optical paths of a signal beam and a reference beam through which each beam is emitted to the holographic information storage medium illustrated in FIG. 3 in a recording mode, according to an embodiment of the present invention;

FIG. 5 is an enlarged diagram of area A illustrated in FIG. 4, according to an embodiment of the present invention;

FIG. 6 illustrates an example of polarization states of a signal beam and a reference beam incident on a holographic information storage medium, according to an embodiment of the present invention;

FIG. 7 illustrates an example of an optical path and polarization state of a light beam incident on a holographic information storage medium in a reproduction mode, according to an embodiment of the present invention; and

FIG. 8 illustrates an example of an optical path and polarization state of a light beam incident on a holographic information storage medium in order to detect a servo, according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

A holographic information recording and/or reproducing apparatus according to aspects of the present invention is an apparatus to record information onto a holographic information storage medium using a single-sided incidence process and to reproduce the recorded information, and includes an optical configuration in which a signal beam and a reference beam are emitted through an identical surface of the holographic information storage medium. The holographic information storage medium employed in the holographic information recording and/or reproducing apparatus according to aspects of the present invention is a reflection-type holographic information storage medium including a recording layer and a reflection layer.

The focus of a signal beam reflected on a reflection layer changes due to the tilt and the like of the reflection-type holographic information storage medium. Accordingly, in order to match a reference beam and a signal beam, the incident angle of at least one of the reference beam and the signal beam should be changed before the beam is incident on an objective lens, thereby adjusting the position of a light spot. For this purpose, for example, a mirror that can be tilted in a 2-dimensional (2D) manner should be inserted in one of the paths of the two beams. Recording layers in which an interference pattern is recorded are superimposed in the direction of the depth of the storage medium to record information in a 3D manner. Thus, when a laser diode (LD) having a short coherence length is used as a light source, by changing the focus of a light beam in the recording layers in the depth direction for information to be recorded in a 3D manner, the difference between the paths of the two beams is generated and the strength of an interference pattern changes. In order to compensate for the difference, an optical system capable of adjusting the path difference of one of the two beams can be employed.

A holographic information recording and/or reproducing apparatus of a single-sided incidence method according to aspects of the present invention includes a tilt optical system to adjust the position of the spot of at least one of a reference beam and a signal beam by changing the incident angle of the beam, and an optical path difference adjustment optical system to enable formation of a satisfactory interference pattern by making the optical path difference of a signal beam and a reference beam fall within a coherence range when information is recorded in a 3D manner.

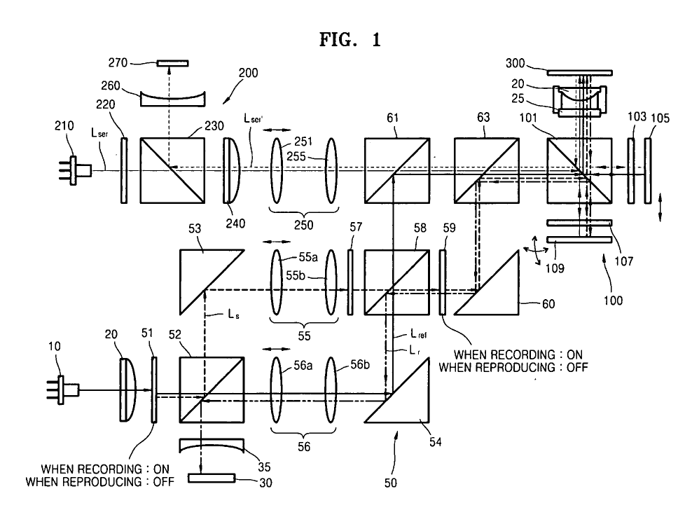

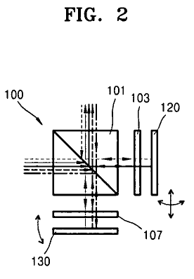

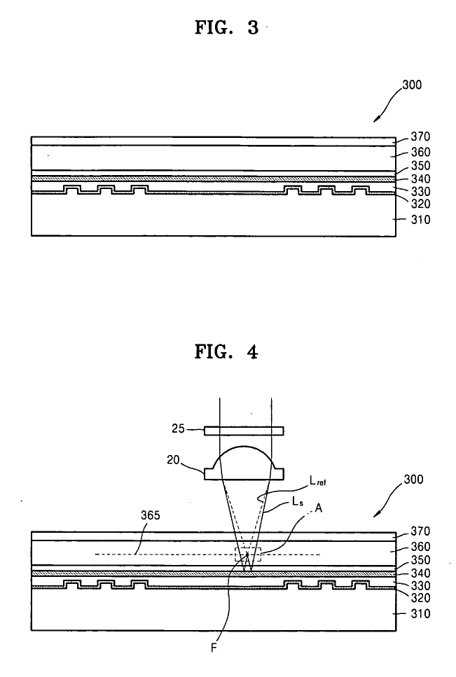

FIG. 1 shows an optical structure of a holographic information recording and/or reproducing apparatus, according to an embodiment of the present invention. FIG. 2 shows another example of the adjustment optical system shown in FIG. 1, according to an embodiment of the present invention. FIG. 3 shows an example of a reflective holographic information storage medium applied to the holographic information recording/reproducing. FIG. 1 shows examples of optical paths of a signal beam (Ls), a reference beam (Lref), a reproduction beam (Lr), a beam (Lser) used to implement a servo, and a beam (Lser′) which includes servo information and which returns after being reflected off a holographic information storage medium 300.

Referring to FIG. 1, the holographic information recording and/or reproducing apparatus includes a first light source 10 to emit light of a predetermined wavelength, a polarization forming optical system 50, a focusing optical system, and an adjustment optical system 100. The polarization forming optical system 50 forms a polarized signal beam (Ls) and a polarized reference beam (Lref), which are incident on a holographic information storage medium 300 through an identical surface from light emitted from the first light source 10 and which are orthogonal to each other. The focusing optical system focuses the signal beam (Ls) and the reference beam (Lref) into the holographic information storage medium 300 so that information can be recorded by an interference pattern. The adjustment optical system 100 sets the focal positions of the signal beam (Ls) and the reference beam (Lref) and adjusts the difference between the path of the signal beam (Ls) and the path of the reference beam (Lref). The holographic information recording and/or reproducing apparatus may further include a servo optical system 200 to read servo information, as shown in FIG. 1; however, the servo optical system need not be included in all aspects of the present invention. According to other aspects of the present invention, the holographic information recording and/or reproducing apparatus may include additional and/or different components. Similarly, the functionality of two or more of the above components may be integrated into a single unit.

An example in which the holographic information recording and/or reproducing apparatus includes the servo optical system 200 to read servo information will now be explained. The first light source 10 can substantially emit a linearly polarized light beam. For example, a laser diode (LD) emitting a blue light beam may be employed as the first light source 10. In a recording mode, according to information desired to be recorded, the first light source 10 emits, for example, a modulated P-polarized beam (L). In a reproduction mode, the first light source 10 can operate so as to emit a non-modulated P-polarized beam (L).

The light beam emitted from the first light source 10 is collimated by a collimating lens 15, and is incident on the polarization forming optical system 50. The structure of the polarization forming optical system 50 which will now be explained is only an example. Aspects of the present invention are not limited to the described structure and can be implemented in a variety of forms.

The polarization forming optical system 50 includes a first polarization changing device 51 to change the polarized light emitted from the first light source 10 so as to include two polarized beams orthogonal to each other. An active polarization changing device may be employed as the first polarization changing device 51. For example, an active wave plate, such as an active half wave plate or an active quarter wave plate, may be employed as the first polarization changing device 51. If an active wave plate is employed, the first polarization changing device 51 functions as a wave plate in a recording mode, thereby converting the light emitted from the first light source 10 to include two linearly polarized beams orthogonal to each other, and does not function as a wave plate in a reproduction mode, thereby allowing the light emitted from the first light source 10 to pass through directly. Of the light converted to include the two linearly polarized beams when the light passes through the first polarization changing device 51, one linearly polarized beam (for example, an S-polarized beam) may be used as the signal beam (Ls) and the other (for example, a P-polarized beam) may be used as the reference beam (Lref).

In this case, the active wave plate may be a liquid crystal device using a double-refraction characteristic of a liquid crystal in which the liquid crystal is arranged to have an optical axis when power is provided. For example, if power is provided to an active half wave plate and the angle between the polarization direction of an incident predetermined linearly polarized beam and the optic axis of the active half wave plate, a fast axis in particular, is an angle other than 45 degrees, then when the incident beam passes through the active half wave plate, the polarization direction of the incident beam is rotated and the beam is converted into two linearly polarized light components orthogonal to each other, an S-polarized component and a P-polarized component. The beams of the S-polarized component and the P-polarized component that are obtained by polarization conversion can be used as the signal beam (Ls) and the reference beam (Lref), respectively, in a recording mode of the apparatus. In the case of an active quarter wave plate, if power is provided and the angle between an incident predetermined linearly polarized beam and the optic axis of the active quarter wave plate is 45 degrees, the beam is polarization-converted into a circularly polarized beam. Since this circularly polarized beam has two linear polarization components orthogonal to each other, the polarization components can be employed as the signal beam (Ls) and the reference beam (Lref), respectively.

The polarization forming optical system 50 may further include an optical structure in which the optical paths of the signal beam (Ls) and the reference beam (Lref) formed as polarized beams orthogonal to each other by the first polarization changing device 51 are separated and transmitted. The optical paths are then combined and the beams are made to be incident on the adjustment optical system 100. The polarization forming optical system 50 may include a first and second optical path changer 52 and 58, a first and second mirrors 53 and 54, a first and second half wave plates 57 and 59, and an optical path combining unit.

The focusing optical system may include an objective lens 20, and may further include at least one focus-changeable lens unit in which the positions of focuses of the signal beam (Ls) and the reference beam (Lref) can be varied with respect to the depth direction of the holographic information storage medium 300. This focus-changeable lens unit may further include a first and second focus-changeable lens unit 55 and 56 disposed on the paths of the signal beam (Ls) and the reference beam (Lref), respectively, in which each beam travels separately. FIG. 1 shows an example in which the first and second focus-changeable lens units 55 and 56 are disposed on the paths of the signal beam (Ls) and the reference beam (Lref), respectively, between the first and second optical path changers 52 and 58.

The first optical path changer 52 separates the light incident from the first polarization changing device 51 into a signal beam (Ls) and a reference beam (Lref) according to the polarization. The second optical path changer 58 is disposed at a location where the signal beam (Ls) and the reference beam (Lref) separated by the first optical path changer 52 intersect. The signal beam (Ls) and the reference beam (Lref) split in the first optical path changer 52 are incident on the second optical path changer 58 through the first and second focus-changeable lens units 55 and 56, respectively. A polarized beam splitter, which is a polarization-selective optical conversion device, can be employed as the first and second optical path changers 52 and 58.

The first and second mirrors 53 and 54 bend the optical paths of the signal beam (Ls) and the reference beam (Lref) separated by the first optical path changer 52 so that the signal beam (Ls) and the reference beam (Lref) can be incident on the second optical path changer 58 and intersect each other.

The first and second half wave plates 57 and 59 are disposed on the path of one of the signal beam (Ls) and the reference beam (Lref), respectively, to the sides of the second optical path changer 58 so that the signal beam (Ls) and the reference beam (Lref) can be transmitted or reflected to intersect with the second optical path changer 58. By doing so, one linearly polarized beam is converted to another polarized beam so that the signal beam (Ls) and the reference beam (Lref) can pass the second optical path changer 58 in identical polarization states. FIG. 1 shows an example in which the first and second half wave plates 57 and 59 are disposed so that both the signal beam (Ls) and the reference beam (Lref) can transmit the second optical path changer 58.

Hereinafter, the rest of the structure will be explained under the assumption that the first and second optical path changers 52 and 58 are disposed to transmit a P-polarized beam and reflect an S-polarized beam, and that the S-polarized beam reflected from the first optical path changer 52 is used as a signal beam (Ls) and the transmitting P-polarized beam is used as a reference beam (Lref). However, this is only an example of some aspects of the present invention; other aspects of the present invention are not limited to this configuration. A holographic information recording and/or reproducing apparatus according to aspects of the present invention can be optically structured so that the S-polarized beam reflected from the first optical path changer 52 can be used as a reference beam (Lref) and the P-polarized beam transmitting the first optical path changer 52 can be used as a signal beam (Ls). The first optical path changer 52 may alternatively be disposed to reflect the P-polarized beam and transmit the S-polarized beam, and the rest of the optical structure may be formed accordingly. Since these variations and embodiments can be sufficiently drawn by a person skilled in the art of the present invention from the technical ideas of the present invention discussed with reference to FIG. 1, detailed explanation will be omitted herein.

When the second optical path changer 58 transmits the P-polarized beam and reflects the S-polarized beam, the first half wave plate 57 converting the S-polarized signal beam (Ls) into a P-polarized beam can be arranged in front of the second optical path changer 58 on which the S-polarized signal beam (Ls) is incident, and the second half wave plate 59 can be arranged on the other side of the second optical path changer. The second half wave plate 59 may include an active wave plate which transmits an incident beam without polarization change in a reproduction mode. The S-polarized signal beam (Ls) reflected from the first optical path changer 52 is converted into a P-polarized beam in the first half wave plate, transmitted to the second optical path changer 58, and is incident on the second half wave plate 59.

In a recording mode, the second half wave plate 59 operates as a half wave plate, thereby converting the incident P-polarized signal beam (Ls) into an S-polarized beam. In a reproduction mode, the second half wave plate 59 does not perform the function as a wave plate, and can transmit the reproduction beam (Lr) from the holographic information storage medium 300 without any changes, as can be seen from the path of the reproduction beam (Lr) shown in FIG. 1. Accordingly, the reproduction beam (Lr) is reflected by the second optical path changer 58.

The first focus-changeable lens unit 55 changes the position of the focus of the signal beam (Ls) in the holographic information storage medium 300 in the depth direction and includes a plurality of lenses 55A and 55B. The second focus-changeable lens unit 56 changes the position of the focus of the reference beam (Lref) in the holographic information storage medium 300 in the depth direction and includes a plurality of lenses 56A and 56B.

At least one of, for example, the lens 55A or lens 56A, is installed such that the lens can be installed to be moved in the optical axis direction, thereby being driven by a driving unit (not shown). The first and second focus-changeable lens units 55 and 56 change the positions of the focuses of the signal beam (Ls) and the reference beam (Lref), respectively, in the holographic information storage medium 300 in the depth direction, thereby enabling information surfaces on which information is recorded to be formed as multiple layers.

The first and second focus-changeable lens units 55 and 56, the two mirrors 53 and 54, the first and second half wave plates 57 and 59, and the second optical path changer 58 are arranged so that each of them can individually adjust the positions of the focuses of the signal beam (Ls) and the reference beam (Lref), and secure an optical path of the reproduction beam (Lr). The holographic information recording and/or reproduction apparatus may alternatively have a structure having only one focus-changeable lens unit on the optical path of the signal beam (Ls) or the reference beam (Lref), without having the two mirrors 53 and 54, the second half wave plates 57 and 59, and the second optical path changer 58.

The optical path combining unit combines the paths of the signal beam (Ls) and the reference beam (Lref) passing through the second optical path changer 58. The optical path combining unit may include, for example, a third optical path changer 61, a third mirror 60, and a fourth optical path changer 63. The third optical path changer 61 unconditionally reflects a beam incident from the second optical path changer 58. The third mirror 60 bends the path of one of the signal beam (Ls) and the reference beam (Lref) that is not incident on the third optical path changer 61 from the second optical path changer 58, for example, the signal beam (Ls), thereby causing the signal beam (Ls) and the reference beam (Lref) to intersect. The fourth optical path changer 63 combines the incident paths of the signal beam (Ls) and the reference beam (Lref) which have different polarizations and intersect with each other by the third optical path changer 61 and the third mirror 60.

The P-polarized reference beam (Lref) passing through the second optical path changer 58 is incident on the third optical path changer 61. If a servo optical system 200 is employed, the third optical path changer 61 may be a wavelength-selective beam splitter. As will be explained later, the light applied to the servo optical system 200 may have a different wavelength from the wavelength of the first light source 10 used for hologram recording and/or reproducing. Accordingly, the third optical path changer 61 may be arranged, for example, so that all the light emitted from the first light source 10 can be reflected irrespective of polarization, and all the light emitted from a second light source 210 of the servo optical system 200 can be transmitted irrespective of polarization. If the servo optical system 200 is not employed, a simple mirror may be used as the third optical path changer 61.

The path of the P-polarized reference beam (Lref) passing through the third optical path changer 61 and the path of the signal beam (Ls) which is converted into a P-polarized beam in the first second wave plate 57, is transmitted through the second optical path changer 58, and is converted into an S-polarized beam when passing through the second half wave plate 59 are combined by the fourth optical path changer 63. The S-polarized signal beam (Ls) output from the second half wave plate 59 is reflected by the third mirror 60 and its path is bent so that the signal beam (Ls) is incident on the fourth optical path changer 63.

A wavelength and/or polarization selective polarization beam splitter can be employed as the fourth optical path changer 63. The wavelength and/or polarization selective polarization beam splitter transmits or reflects the light emitted from the first light source 10 according to polarization and transmits the light emitted from the second light source 210 of the servo optical system 200 irrespective of polarization.

For example, the fourth optical path changer 63 transmits the P-polarized reference beam (Lref) incident from the third optical path changer 61 and the light emitted from the second light source 210 of the servo optical system 200, and reflects the S-polarized signal beam (Ls) incident from the second half wave plate and bent by the third mirror 60. In this case, the positions of the servo optical system 200 and the third optical path changer 61 may be switched for the position of the third mirror 60. In such a case, the fourth optical path changer 63 can be arranged so as to reflect the P-polarized reference beam (Lref) incident from the third optical path changer 61 and the servo light emitted from the second light source 210 of the servo optical system 200, and to transmit the S-polarized signal beam (Ls) incident from the second half wave plate 59 with the path of the S-polarized signal beam (Ls) bent by the third mirror 60.

The adjustment optical system 100 adjusts the angle of incidence on the objective lens 20 of at least one beam of the signal beam (Ls) and the reference beam (Lref) incident from the fourth optical path changer 63, and adjusts the path difference between the signal beam (Ls) and the reference beam (Lref), thereby causing the beams to proceed to the holographic information storage medium 300 through the objective lens 20.

The adjustment optical system 100 includes a first adjustment member 100, a second adjustment member 105, and a polarization separation device 101. The first adjustment member 100 sets the focal positions of the signal beam (Ls) and the reference beam (Lref) in the holographic information storage medium 300. The second adjustment member 105 adjusts the path difference between the signal beam (Ls) and the reference beam (Lref). The polarization separation device 101 separates the polarized signal beam (Ls) and the polarized reference beam (Lref), which are incident from the polarization forming optical system 50 and which are orthogonal to each other, into two paths according to the polarization, so that the signal beam (Ls) and the reference beam (Lref) can be directed to the first adjustment member 109 and the second adjustment member 105, respectively.

A polarization beam splitter may be employed as the polarization separation device 101. In this case, the adjustment optical system 100 may further include quarter wave plates 107 and 103 that convert linearly polarized beams incident between the first adjustment member 109 and the polarization separation device 101 and between the second adjustment member 105 and the polarization separation device 101, respectively, into circularly polarized beams. After the polarized signal beam (Ls) and the polarized reference beam (Lref) orthogonal to each other are reflected by the first and second adjustment members 109 and 105, the paths of the signal beam (Ls) and the reference beam (Lref) can be combined by the polarization separation device 101, and the signal beam (Ls) and the reference beam (Lref) can be transmitted to the objective lens 20.

The first adjustment member 109 may be a tilt mirror that can adjust an angle of incidence on the objective lens 20 by adjusting the reflection angle of an incident beam. For example, the first adjustment member 109 may be a 2D tilt mirror by which the reflection angle of an incident beam can be adjusted in a 2D manner. A translation mirror that can adjust the length of an optical path of an incident beam so that the signal beam (Ls) and the reference beam (Lref) can overlap within a possible interference distance can be employed as the second adjustment member 105. The tilt mirror and the translation mirror are driven by respective driving units (not shown).

When a 2D tilt mirror is employed as the first adjustment member 109, the adjustment optical system 100 is constructed so that the signal beam (Ls) can be incident on the first adjustment member 109. By adjusting the incident angle of the signal beam (Ls) on the objective lens 20, the positions of the focuses of the signal beam (Ls) and the reference beam (Lref) may be set. The reason for this will now be explained. If the reference beam (Lref) is focused directly on a recording location in the holographic information storage medium 300, the signal beam (Ls) is reflected by the reflection layer of the holographic information storage medium 300, and the signal beam (Ls) is focused on the recording location, then the signal beam (Ls) responds more sensitively to tilt and the like of the holographic information storage medium 300 than the reference beam (Lref). In addition, if the effective numerical aperture of the lens optical system is large, the tilt and the like of the holographic information storage medium 300 influences the focused light significantly.

Accordingly, the lens optical system of the holographic information recording and/or reproducing apparatus should be constructed so that the effective numerical aperture of a lens optical system related to the signal beam (Ls) (for example, the first focus-changeable lens unit 55 and the objective lens 20) is equal to or less than the effective numerical aperture of a lens optical system related to the reference beam (Lref) (for example, the second focus-changeable lens unit 56 and the objective lens 20). If the lens optical system is thus constructed, the signal beam (Ls) is less sensitive to adjustment of the angle of incidence on the objective lens 20, and therefore, it is advantageous to set the positions of the focuses of the signal beam (Ls) and the reference beam (Lref) by adjusting the angle of incidence of the signal beam (Ls). Accordingly, the adjustment optical system can be constructed so that the signal beam (Ls) is incident on the first adjustment member 109 and the reference beam (Lref) is incident on the second adjustment member 105.

The S-polarized signal beam (Ls) and the P-polarized reference beam (Lref) are incident on the polarization separation device 101 of the adjustment optical system 100 from the fourth optical path changer 63. Accordingly, the polarization separation device 101 can be arranged, for example, so as to reflect the S-polarized signal beam (Ls), thereby directing the beam to the first adjustment member 109, and to transmit the P-polarized reference signal (Lref), thereby directing the beam to the second adjustment member 105.

In this case, the S-polarized signal beam (Ls) reflected by the polarization separation device 101 is converted into a circularly polarized beam by the quarter wave plate 107, and when reflected by the first adjustment member 109, is converted into another circularly polarized beam. When passing through the quarter wave plate 107, this circularly polarized beam is converted into a P-polarized beam, and this P-polarized signal beam (Ls) is transmitted through the polarization separation device 101.

The P-polarized reference beam (Lref) transmitted through the polarization separation device 101 is changed into a circularly polarized beam by the quarter wave plate 103, and when reflected by the second adjustment member 105, is converted into another orthogonal circularly polarized beam. When passing through the quarter wave plate 103, this orthogonal circularly polarized beam is converted into an S-polarized beam. This S-polarized reference beam (Lref) is reflected by the polarization separation device 101, thereby combining the paths of the S-polarized reference beam (Lref) and the P-polarized signal beam (Ls), and directing the combined paths to the objective lens 20. Accordingly, in the recording mode, the S-polarized reference beam (Lref) and the P-polarized signal beam (Ls) are emitted toward the objective lens 20. In the reproduction mode, since the first polarization changing device 51 is turned off so as not to function as a wave plate, only the S-polarized reference beam (Lref) is emitted toward the objective lens 20.

As described above, when the position of the focus of the signal beam (Ls) reflected by the reflection layer 340 shown in FIG. 3 changes by tilt and the like of the holographic information storage medium 300, the adjustment optical system 100 can match the focuses of the reference beam (Lref) and the signal beam (Ls) in the holographic information storage medium 300 by changing the incident angle of either the reference beam (Lref) or the signal beam (Ls) using the first adjustment member 109 formed with a 2D tilt mirror, before the beams are incident on the objective lens 20.

A path difference between the signal beam (Ls) and the reference beam (Lref), is generated when the positions of the focuses of the signal beam (Ls) and the reference beam (Lref) in a recording layer are changed in the depth direction in order to record information in a 3D manner by superimposing layers in which interference patterns are recorded in the depth direction of the holographic information storage medium 300. This path difference can be compensated for using the second adjustment member 105 formed with a translation mirror.

By using this second adjustment member 105, even when an LD having a short coherence length is used as the first light source 10, the optical path difference between the signal beam (Ls) and the reference beam (Lref) can be made to fall within the coherence length range, thereby improving the problem where the strength of an interference is changed by the path difference. Accordingly, a satisfactory interference pattern can be formed.

FIG. 2 shows another example of the adjustment optical system 100 shown in FIG. 1 according to an embodiment of the present invention. As shown in FIG. 2, the adjustment optical system 100 may include a 1D tilt mirror capable of adjusting the reflection angle of an incident beam as a first adjustment member 130, and a translation/1D tilt mirror capable of adjusting the length of optical path of the incident beam and the reflection angle of an incident beam in the direction different from that of the first adjustment member 109 as a second adjustment member 120.

Since adjustment of an optical path difference may be necessary to set a coherence length in movement across layers, and driving of a tilt mirror is used when information is recorded or reproduced within a layer, a tilt operation and a translation operation can be performed separately. In addition, implementation of a 1D tilt function and a 1D translation function in a single device is simpler than manufacturing a 2D tilt mirror. Accordingly, construction of the adjustment optical system 100 including a 1D tilt mirror and a translation/1D tilt mirror has a sufficient advantage.

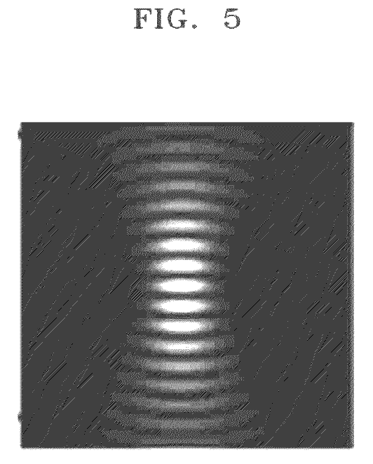

Referring again to FIG. 1, the objective lens 20 condenses a signal beam (Ls), a reference beam (Lref), and a reproduction beam (Lr) that are beams for recording and/or reproducing information, onto a predetermined area of the holographic information storage medium 300. As described above, the focal length of the objective lens 20 with respect to the signal beam (Ls) and the reference beam (Lref) can be changed by the first and second focus-changeable lens units 55 and 56. By making the focal length of the reference beam (Lref) shorter than the focal length of the signal beam (Ls), the reference beam (Lref) can be directly condensed onto a focus (F) shown in FIG. 4, and the signal beam (Ls) can be condensed on the focus (F) after reflecting off a reflection layer 340 shown in FIG. 4. This optical design may vary with respect to specific positional relationships between optical devices, and specifications of the holographic information storage medium 300.

The holographic information recording and/or reproducing apparatus may further include a wave plate converting the polarization of an incident beam between the objective lens 20 and the adjustment optical system 100, for example, a quarter wave plate 25, and a first photodetector 30 receiving a reproduction beam (Lr) obtained by reproducing a hologram recorded in the holographic information storage medium 300.

In a recording mode, the quarter wave plate 25 converts an S-polarized reference beam (Lref) and a P-polarized reference beam (Ls) incident from the adjustment optical system 100 into circularly polarized beams orthogonal to each other. In a reproduction mode, the quarter wave plate 25 converts an S-polarized reference beam (Lref) incident from the adjustment optical system 100 into a circularly polarized beam.

The first photodetector 30 can be arranged so that in a reproduction mode, when a reference beam (Lref) is emitted from the first light source 10 to the holographic information storage medium, a reproduction beam (Lr) obtained by reproducing a hologram from the holographic information storage medium can travel along the return path shown in FIG. 1 and can be separated in the first optical path changer 52 and received by the first photodetector 30. A detection lens 35 to condense the reproduction beam (Lr) in an appropriate size into the first photodetector 30 may be further arranged between the first photodetector 30 and the first optical path changer 52.

Because of the presence of the quarter wave plate 25, the reproduction beam (Lr) reproduced from the holographic information storage medium 300 is incident on the adjustment optical system 100 in a P-polarized state. In a reproduction mode, since the second half wave plate 59 is turned off so as not to perform the function of a wave plate, the reproduction beam (Lr) is received by the first photodetector 30 through the optical path shown in FIG. 1.

The holographic information recording and/or reproducing apparatus may further include a servo optical system 200 as described above. As will be described below, the holographic information storage medium 300 used in the holographic information recording and/or reproducing apparatus may have a servo layer 320 as shown in FIG. 4. The servo optical system 200 reads out servo information recorded in the servo layer 320.

The servo optical system 200 may include a second light source 210, a fifth optical path changer 230, and a second photodetector 270. The servo optical system 200 may further include a second collimating lens 240 and a third focus-changeable lens unit 250. The second light source 210 emits light to implement a servo. The second light source 210 may be, for example, a semiconductor LD emitting a red light beam having a wavelength different from that of a beam emitted by the first light source 10 for recording and/or reproducing.

The second light source 210 may emit a linearly polarized beam in one direction. The beam emitted from the second light source 210 travels to the objective lens 20 through the adjustment optical system 100 described above. In this case, the beam emitted to the holographic information storage medium 300 for implementation of a servo may pass through the second adjustment member 105 performing the function of a translation mirror rather than the first adjustment member 109 performing the function of a tilt mirror. Accordingly, considering the polarization forming optical system 50 and the adjustment optical system 100, the second light source 210 can be configured to emit a P-polarized beam.

The fifth optical path changer 230 may include, for example, a polarization selective beam splitter designed to transmit a P-polarized beam and reflect an S-polarized beam, so that the beam incident from the second light source 210 and the beam including servo information reflected by the holographic information storage medium 300 can be separated according to the polarization direction.

The servo optical system 200 may further include a diffraction grating 220 between the second light source 210 and the fifth optical path changer 230. This diffraction grating 220 diffracts the beam emitted from the second light source 210 into a 0-th order diffraction beam or ±first order diffraction beam, thereby enabling servo error signal detection using a 3-beam method or a differential push-pull method. The second collimating lens 240 collimates the beam emitted from the second light source 210 into a parallel beam.

The third focus-changeable lens unit 250 varies the position of the focus of a servo beam in the holographic information storage medium 300 in the depth direction, and may include a plurality of lenses 251 and 255 in which at least one lens 251 is installed movably in the optical axis direction, thereby being driven by a driving unit (not shown). A second detection lens 260 may further be included between the fifth optical path changer 230 and the second photodetector 270. This second detection lens 260 forms an appropriate spot of a reflected beam including servo information on the second photodetector 270. An astigmatism lens enabling error signal detection by an astigmatism method can be employed as the second detection lens 260.

The second photodetector 270 may include a plurality of photo-detection portions to detect servo information included in the servo layer 320 shown in FIG. 4 of the holographic information storage medium 300 or a servo error signal. The servo optical system 200 described above is only an example of an optical system for a case where a beam having a wavelength different from that of the recording and/or reproducing beam is used; aspects of the present invention are not limited to this configuration.

FIG. 3 shows an example of a holographic information storage medium 300 used in a holographic information recording and/or reproducing apparatus, according to an embodiment of the present invention. The holographic information storage medium 300 shown in FIG. 3 is a reflection-type holographic information storage medium, which is disclosed in Korean Patent Application No. 10-2007-0091445 filed by the present applicant.

Referring to FIG. 3, the holographic information storage medium 300 may have a structure in which a substrate 310, a servo layer 320, a buffer layer 330, a reflection layer 340, a space layer 350, a recording layer 360, and a cover layer 370 are sequentially laminated. The servo layer 320 is a layer in which servo information is recorded, and reflects a servo beam. The buffer layer 330 may be formed of a transparent material or a material that is transparent with respect to a wavelength of a servo beam and absorbent with respect to the wavelength of a beam for recording and/or reproduction. The reflection layer 340 reflects a signal beam (Ls). The signal beam (Ls) reflected by this reflection layer 340 is condensed into a focus (F) shown in FIG. 4 in the recording layer 350. The reflection layer 340 may be designed so as to transmit a beam used to implement a servo. In order to reduce noise, the reflection layer 340 may be designed so as to transmit a reference beam (Lref) so that the reference beam (Lref) cannot act as noise by avoiding a case where the reference beam (Lref) passing through a hologram recording position without change is reflected by this reflection layer 340, thereby returning to the hologram recording position again and acting as noise. The space layer 350 is a layer to secure a space between the recording layer 360 and the reflection layer 340. The recording layer 360 may be formed of a photo-reactive material whose refractive index is changed when light is absorbed. The recording layer 360 may be formed of a photopolymer or a thermoplastic material. The cover layer 370 is a layer to protect the recording layer 360 from being exposed to the outside.

A process of recording and/or reproducing information of a holographic information recording and/or reproducing apparatus, according to an embodiment of the present invention will now be explained with reference to FIGS. 4 through 8. First, a recording mode of a holographic information recording and/or reproducing apparatus according to an embodiment of the present invention will be explained. FIG. 4 shows optical paths of a signal beam and a reference beam through which each beam is emitted to the holographic information storage medium 300 shown in FIG. 3 in a recording mode, according to an embodiment of the present invention. FIG. 5 is an enlarged diagram of area A shown in FIG. 4, according to an embodiment of the present invention.

Referring to FIG. 4, a signal beam (Ls) of P-polarization and a reference beam (Lref) of S-polarization orthogonal to each other travel through a wave plate and an objective lens 20, and are incident on an identical surface of the holographic information storage medium 300. The signal beam (Ls) passes through the cover layer 370 and the recording layer 360, reflects off the reflection layer 340, and is condensed onto a focus (F) in the recording layer 360. The reference beam (Lref) passes through the cover layer 370, and then, is directly condensed on the focus (F) in the recording layer 360.

As the spot of the signal beam (Ls) and the spot of the reference beam (Lref) thus overlap on the focus (F), an interference pattern is formed. Since the shape of this interference pattern varies with respect to the modulation state of the signal beam (Ls), information can be recorded by the interference pattern. FIG. 5 is an enlarged diagram of the vicinity (A) of the focus (F) of the signal beam (Ls) and the reference beam (Lref) shown in FIG. 4, and shows a formed interference pattern. This interference pattern is recorded along a track on an identical plane, thereby forming an information surface 365 of a single layer in the holographic recording layer 360. By superimposing interference patterns in the depth direction of the holographic recording layer 360 by varying the positions of the focuses of the signal beam (Ls) and the reference beam (Lref), information can be recorded in multiple layers. In the holographic information storage medium 300, information can be recorded in a microholographic manner by which information of a single bit is included in an interference pattern at each focus (F). However, aspects of the present invention are not limited to this. For example, information can also be recorded in a volume holographic manner by which multiple information items can be recorded in an interference pattern in a 3D manner by superimposing the spot of the signal beam (Ls) and the spot of the reference beam (Lref) on the focus (F).

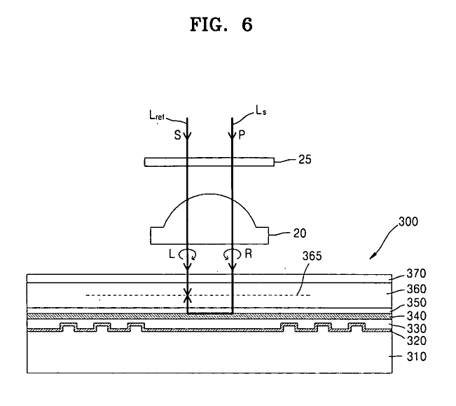

FIG. 6 shows an example of polarization states of a signal beam (Ls) and a reference beam (Lref) incident on a holographic information storage medium 300, according to an embodiment of the present invention. The signal beam (Ls) and the reference beam (Lref) having different polarizations are incident on a quarter wave plate 25. For example, the signal beam (Ls) having a P-polarized state is incident on the quarter wave plate 25, and the reference beam (Lref) having an S-polarized state is incident on the quarter wave plate 25.

When passing through the quarter wave plate 25, the polarization state of the signal beam (Ls) is converted into a right circular polarization state (R), and the polarization state of the reference beam (Lref) is converted into a left circular polarization state (L). The signal beam (Ls) having the right circular polarization state (R) is reflected directly by the reflection layer 340, and maintains the right circular polarization state (R). The reflected signal beam (Ls) of the right circular polarization (R) is focused on an information surface 365. The reference beam (Lref) having a left circular polarization state (L) passes through the cover layer 370 and is focused directly on the information surface 365. Since the signal beam (Ls) and the reference beam (Lref) meeting on the information surface 365 proceed facing each other and have circular polarized states opposite to each other, the electric field vectors of the signal beam (Ls) and the reference beam (Lref) rotate in an identical direction, thereby causing an interference on the recording layer 365. This interference causes the information to be recorded on the holographic recording layer 360.

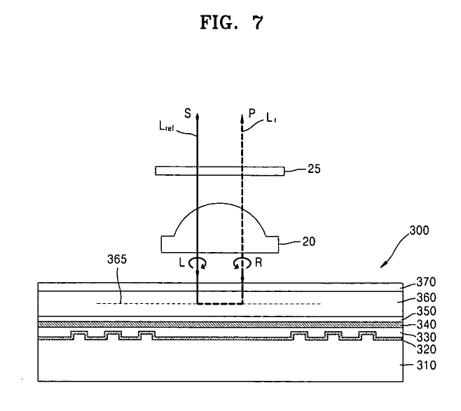

A reproduction mode of a holographic information recording and/or reproducing apparatus according to an embodiment of the present invention will now be explained with reference to FIG. 7. FIG. 7 shows an example of an optical path and polarization state of a light beam incident on the holographic information storage medium 300 in a reproduction mode, according to an embodiment of the present invention.

A reference beam (Lref) is emitted on the holographic information storage medium 300 in order to reproduce information. The reference beam (Lref) passes through a quarter wave plate 25 and an objective lens 20, and is focused directly on an information surface 365 in which information of a recording layer 360 is recorded. The S-polarized reference beam (Lref) is converted into a left circularly polarized state (L) through the quarter wave plate 25, and is incident on the holographic information storage medium 300 through the objective lens 20. The reference beam (Lref) incident in the left circularly polarized state (L) is diffracted (reflected) from the information surface 365 by an interference pattern, thereby being directed to the objective lens 20 again. Since only the proceeding direction of the reproduction beam (Lr) reflected by the information surface 365 changes, and the rotation direction of the electric field vector of the reproduction beam (Lr) does not change, the reproduction beam (Lr) is in a right circularly polarized state (R). The reproduction beam (Lr) having the right circularly polarized state (R) is again converted into a P-polarized beam when passing through the quarter wave plate 25, and travels the reverse path of the optical path of the signal beam (Ls) in the recording mode. Since the second half wave plate 59 does not perform the function of a wave plate as shown in FIG. 1, the reproduction beam (Lr) is reflected by the second optical path changer 58, reflected by the first optical path changer 52, and detected in the first photodetector 30.

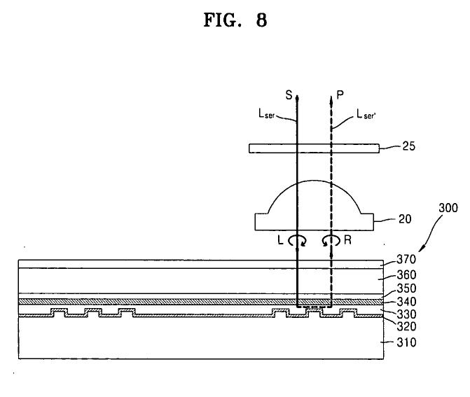

Detection of servo information in a holographic information recording and/or reproducing apparatus according to an embodiment of the present invention will now be explained with reference to FIG. 8. A beam (Lser) used to implement a servo of a linear polarization, for example, P polarization, is converted into an S-polarized beam when passing through the adjustment optical system 100 shown in FIG. 1, and is incident on a holographic information storage medium 300 through a quarter wave plate 25 and an objective lens 20. The beam (Lser) is converted into a left circularly polarized beam when passing through the quarter wave plate 25. The beam (Lser) incident on the holographic information storage medium 300 is reflected by a servo layer 320, thereby becoming a servo beam (Lser′) having servo information. In this case, since the rotation direction of the polarization vector of the servo beam (Lser′) does not change but the proceeding direction is reversed, the left circularly polarized beam becomes a right circularly polarized beam. The reflected servo beam (Lser′) is again converted into a P-polarized beam through the quarter wave plate 25, and travels the reverse path of the optical path of the reference beam (Lref) in the recording or reproduction mode, thereby becoming an S-polarized beam and incident on the fourth optical path changer 63. The servo beam (Lser′) is transmitted sequentially through the fourth and third optical path changer 63 and 61, and is reflected by the fifth optical path changer 230 of the servo optical system 200, and detected by the second photodetector 270.

According to aspects of the present invention, a single-sided incidence manner holographic information recording and/or reproducing apparatus capable of reducing the sizes and the number of components of a tilt optical system and an optical path difference adjustment optical system for adjusting the spot position of at least one beam of a signal beam and a reference beam that are incident on a single surface can be implemented.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A holographic information recording and/or reproducing apparatus comprising:
a light source to emit light;
a polarization forming optical system to form a polarized signal beam and a polarized reference beam from the light emitted from the light source, wherein the polarized signal beam and the polarized reference beam are orthogonal to each other and incident on a holographic information storage medium through an identical surface;
a focusing optical system to focus the polarized signal beam and the polarized reference beam onto the holographic information storage medium so as to record information by an interference pattern; and
an adjustment optical system to set the focal positions of the polarized signal beam and the polarized reference beam, and to adjust a difference between a path of the polarized signal beam and a path of the polarized reference beam;
wherein the adjustment optical system comprises:
a first adjustment member to set the focal positions of the polarized signal beam and the polarized reference beam emitted on the holographic information storage medium;
a second adjustment member to adjust the path difference between the polarized signal beam and the polarized reference beam; and
a polarization separation device to separate the polarized signal beam and the polarized reference beam, which are incident from a first optical system, into two paths based on the beams' polarization so as to direct the polarized signal beam to the first adjustment member and the polarized reference beam to the second adjustment member.

2. The apparatus of claim 1, wherein the first adjustment member is a 2-dimensional (2D) tilt mirror to adjust the reflection angle of an incident beam in two dimensions.

3. The apparatus of claim 2, wherein the second adjustment member is a translation mirror to adjust the optical path length of the incident beam.

4. The apparatus of claim 1, wherein the first adjustment member is a one-dimensional (1D) tilt mirror to adjust the reflection angle of an incident beam.

5. The apparatus of claim 4, wherein the second adjustment member is a translation and a 1D tilt mirror to adjust the optical path length of the incident beam and to adjust the reflection angle of the incident beam in a direction different from that of the first adjustment member.

6. The apparatus of claim 1, wherein the adjustment optical system further comprises:
a first quarter wave plate arranged between the polarization separation device and the first adjustment member; and
a second quarter wave plate arranged between the polarization separation device and the second adjustment member; wherein
the polarization separation device is a polarization beam splitter.

7. The apparatus of claim 6, wherein the polarized signal beam is incident on the first adjustment member and the polarized reference beam is incident on the second adjustment member.

8. The apparatus of claim 1, wherein the polarized signal beam is incident on the first adjustment member and the polarized reference beam is incident on the second adjustment member.

9. The apparatus of claim 1, wherein the holographic information storage medium comprises:
a recording layer; and
a reflection layer;
wherein the focusing optical system causes the polarized signal beam to pass through the recording layer of the holographic information storage medium, reflect off the reflection layer, and condense in the recording layer, and causes the polarized reference beam to be condensed in the recording layer without passing through the recording layer or reflecting off the reflection layer.

10. The apparatus of claim 9, wherein the polarized light forming optical system comprises an active polarization changing device to convert the polarization of a beam emitted from the light source during a recording mode so as to include a first beam and a second beam having orthogonal polarizations, and to transmit the beam emitted from the first light source without changing polarization during a reproduction mode.

11. The apparatus of claim 10, wherein the polarized light forming optical system separates the optical paths of the polarized signal beam and the polarized reference beam, transmits the polarized signal beam and the polarized reference beam, and combines the optical paths so as to cause the polarized signal beam and the polarized reference beam to be incident on the adjustment optical system.

12. The apparatus of claim 11, wherein the polarized light forming optical system comprises:
a first optical path changer to separate the beam emitted from the light source into the first beam and the second beam;
a second optical path changer arranged at a location where the first and second beams separated by the first optical path changer intersect, to separate an incident beam according to the polarization of the beam;
a first mirror and a second mirror to bend optical paths of the first beam and the second beam separated by the first optical path changer so that the first and second beams intersect and are incident on the second optical path changer;
a first half wave plate and a second half wave plate arranged on one of the paths of the first and second beams at sides of the second optical path changer so as to convert one linearly polarized beam into the other polarized state, so that the first and second beams is transmitted from the second optical path changer in an identical polarization state; and
an optical path combining unit to combine the paths of the first and second beams transmitted from the second optical path changer;
wherein one of the first and second beams is the polarized signal beam and the other of the first and second beams is the polarized reference beam.

13. The apparatus of claim 12, wherein the optical path combining unit comprises:
a third optical path changer to unconditionally reflect a beam incident from the second optical path changer;
a third mirror to bend the path of one beam of the first and second beams so as to make the first and second beams intersect, the one beam not being directed to the third optical path changer from the second optical path changer; and
a fourth optical path changer to combine the paths of the first and second beams having different polarizations, wherein the first and second beams are incident and are intersecting each other by the third optical path changer and the third mirror.

14. The apparatus of claim 12, wherein one of the first and second half wave plates, on which the first or second beam incident on the second optical path changer from the first optical path changer is incident after passing through the second optical path changer, is an active wave plate operated to pass incident light without polarization change while the apparatus is operating in a reproduction mode.

15. The apparatus of claim 11, wherein the focusing optical system comprises an objective lens.

16. The apparatus of claim 15, wherein the focusing optical system further comprises a focus-changeable lens unit to vary the position of the focuses of the polarized signal beam and the polarized reference beam in the depth direction of the holographic information storage medium.

17. The apparatus of claim 16, wherein:
the focus-changeable lens unit comprises a first focus-changeable lens unit and a second focus-changeable lens unit arranged along paths of the polarized signal beam and the polarized reference beam, respectively, and
each of the polarized signal beam and the polarized reference beam travels separately.

18. The apparatus of claim 15, further comprising:
a wave plate to convert a polarization of an incident beam between the objective lens and the adjustment optical system; and
a photodetector to receive a reproduction beam reproduced from the holographic information storage medium while the apparatus is in a reproduction mode.

19. The apparatus of claim 9, wherein the polarized signal beam is incident on the first adjustment member and the polarized reference beam is incident on the second adjustment member.

20. The apparatus of claim 1, further comprising a servo optical system to record and/or reproduce servo information onto/from the holographic information storage medium.

21. An adjustment optical system of a holographic recording and/or reproducing apparatus, the adjustment optical system comprising:
a first adjustment member to set focal positions of a signal beam and a reference beam emitted onto a holographic information storage medium;
a second adjustment member to adjust a path difference between the signal beam and the reference beam so as to compensate for a path difference between the signal beam and the reference beam; and
a polarization separation device to separate the signal beam and the reference beam into a first path for the signal beam and a second path for the reference beam based on a polarization of the signal beam and the reference beam, so as to direct the signal beam to the first adjustment member and the reference beam to the second adjustment member.

22. The adjustment optical system of claim 21, further comprising:
a first quarter wave plate arranged between the polarization separation device and the first adjustment member; and
a second quarter wave plate arranged between the polarization separation device and the second adjustment member.

23. The adjustment optical system of claim 21, wherein the polarization separation device is a polarization beam splitter.

24. The adjustment optical system of claim 21, wherein the first adjustment member is a one-dimensional (1D) tilt mirror to adjust a reflection angle of an incident beam.

25. The adjustment optical system of claim 21, wherein the second adjustment member is a translation/1D tilt mirror to adjust a length of an optical path of an incident beam and to adjust a reflection angle of the incident beam in a direction different than that of the first adjustment member.

26. A polarized light forming optical system of a holographic recording and/or reproducing apparatus, the polarized light forming optical system comprising:
a first polarization changing device to change light emitted from a light source into a first polarized beam and a second polarized beam orthogonal to the first polarized beam;
a first optical path changer to separate the first polarized beam and the second polarized beam;
a first mirror to bend a path of the first polarized beam and a second mirror to bend a path of the second polarized beam so as to cause the first polarized beam to intersect the second polarized beam at a second optical path changer;
a first half wave plate and a second half wave plate arranged on one of the paths of the first polarized beam and the second polarized beam and arranged at different sides of the second optical path changer, to convert the first polarized beam or the second polarized beam into another polarized state so as to cause the first polarized beam and the second polarized beam to be transmitted from the second optical path changer in an identical polarization state; and
an optical path combining unit to combine the paths of the first polarized beam and the second polarized beam after the first polarized beam and the second polarized beam are transmitted from the second optical path changer;
wherein one of the first polarized beam and the second polarized beam is a signal beam and the other of the first polarized beam and the second polarized beam is a reference beam.

27. The polarized light forming optical system of claim 26, wherein one of the first half wave plate and the second half wave plate is an active wave plate to pass incident light without changing a polarization of the light when the holographic recording and/or reproducing apparatus is operating in a reproduction mode to reproduce data from a holographic information storage medium.

28. A holographic recording and/or reproducing apparatus, comprising:
a first light source;
a polarization forming optical system to form a polarized reference beam and a polarized signal beam having orthogonal polarizations from light emitted by the first light source; a focusing optical system to focus the polarized reference beam and the polarized signal beam on an identical surface of a holographic information storage medium so as to record information via an interference pattern; and
an adjustment optical system to adjust a path difference between the polarized reference beam and the polarized signal beam so as to compensate for the path difference between the signal beam and the reference beam.

29. The holographic recording and/or reproducing apparatus of claim 28, further comprising a servo optical system to record and/or reproduce servo information onto/from the holographic information storage medium.

30. The holographic recording and/or reproducing apparatus of claim 29, wherein the servo optical system comprises:
a second light source to emit a P-polarized beam;
an optical path changer to transmit the P-polarized beam and to reflect an S-polarized beam; and
a focus-changeable lens unit to vary a focus position of a servo beam in the holographic information storage medium.

31. The holographic recording and/or reproducing apparatus of claim 30, wherein the servo optical system further comprises:
a diffraction grating arranged between the second light source and the optical path changer to diffract the P-polarized beam so as to enable servo error signal detection.
